(19) United States
(12) Patent Application Publication
(10) Pub. No.: US 2025/0293917 A1
(43) Pub. Date: Sep. 18, 2025

(54) AUTO-HEALING CONTROL IN CONSIDERATION OF SILENT FAILURES

(71) Applicant: Rakuten Mobile, Inc., Tokyo (JP)

(72) Inventor: Masaaki Kosugi, Tokyo (JP)

(73) Assignee: Rakuten Mobile, Inc., Tokyo (JP)

(21) Appl. No.: 18/757,840

(22) Filed: Jun. 28, 2024

(30) Foreign Application Priority Data
Mar. 14, 2024 (JP) 2024-039947

(51) Int. Cl. H04L 41/0654; H04L 41/08; H04L 41/40

(52) U.S. Cl. CPC H04L 41/0654; H04L 41/0886; H04L 41/40

(57) ABSTRACT

A network management apparatus includes at least one processor. The processor is configured to execute a reception process of receiving a signal supplied when degradation in performance of a VNF or CNF exceeding a threshold value is detected in a network virtualization environment, a specifying process of specifying a hardware resource related to performance degradation when the signal is received, and a first command transmission process of transmitting a command to perform auto-healing so as to deploy a hardware resource other than the specified hardware resource for the VNF or CNF having degraded performance.

### CROSS-REFERENCE TO RELATED APPLICATION(S)

This application claims priority to Japanese patent application No. 2024-039947, filed on Mar. 14, 2024; the entire contents of which are incorporated herein by reference.

### TECHNICAL FIELD

The present disclosure relates to auto-healing control in consideration of silent failures.

### BACKGROUND

The information disclosed in this background section is only for enhancement of understanding of the general background of the disclosure and should not be taken as an acknowledgement or any form of suggestion that this information forms the prior art already known to a person skilled in the art.

Cloud computing (referred to as a “cloud” below) in which computing resources virtualized on physical resources such as servers are used on demand has become widely spread against the background of improvement in performance of general-purpose servers and enrichment of network infrastructure. In addition, network function virtualization (NFV) in which network functions are virtualized and provided on a cloud is known. NFV is a technology in which a virtualization technology and a cloud technology are used to separate hardware and software of various network services that have been running on dedicated hardware until now and to run the software on a virtualized infrastructure. With NFV, it is expected to enhance operation and reduce costs.

In recent years, virtualization has also been promoted in mobile networks.

In European Telecommunications Standards Institute (ETSI) NFV, an architecture of NFV is defined (see WO 2016/121830 A, for example).

### SUMMARY OF THE INVENTION

In auto-healing defined by ETSI NFV or the like, in a case in which a problem is detected, a VNF or CNF having the problem is automatically saved on a normal hardware resource, thereby enabling quick service recovery. In auto-healing, a VNF or CNF having the problem is deleted, other hardware resources are deployed for the VNF or CNF (creating the VNF or CNF), and settings are performed to optimize the operation of the VNF or CNF.

Generally, problems that trigger auto-healing are roughly classified into two types. One type is a problem of a hardware resource on which the VNF/CNF operates (such as a physical failure), and the other type is a problem of the VNF/CNF itself (such as a software bug in an application).

On the other hand, there are silent failures that cannot be classified into the above-described types. In a network virtualization environment, performance degradation that is not detected from a normal operation monitoring mechanism is referred to as “silent failures”. Leaving silent failures untouched may affect the entire system, such as eventual failure in connection to the network, leading to even larger problems.

Cause of a silent failure is supposed to be a physical defect of hardware or a defect of software such as firmware operating on hardware.

However, it often takes a lot of time and effort to identify an occurrence location and cause of silent failures. Therefore, a user tends to suffer a disadvantage associated with performance degradation for a long time, and the service provider may suffer a reputation risk for a long time.

As described above, a silent failure is not detected by a normal operation monitoring mechanism. Therefore, unless a silent failure causes a problem that triggers auto-healing, auto-healing is not performed.

On the other hand, in a mobile network based on the NFV, in a case in which there is no report of an alert for notifying an abnormality (which may trigger auto-healing) and a phenomenon such as performance degradation of a component has occurred, auto-scaling or human performance expansion may be performed.

Auto-scaling is a process of balancing a processing load by automatically adding a new component (VNF or CNF) when the processing load of the component exceeds an allowable value in a network virtualization environment. The human performance expansion is a process of balancing a processing load by adding a new component (VNF or CNF) by a human.

The added components may exhibit favorable performance by both auto-scaling or human performance expansion. However, components having degraded performance are also continuously used. Therefore, a silent failure continues, an adverse effect on the service for a user who uses the component continues, and in some cases, a larger problem may occur.

Accordingly, the present disclosure provides an automation technology capable of minimizing adverse effects on a service as quickly as possible in a case in which degradation in performance of a component that can cause a silent failure occurs.

According to an aspect of the present disclosure, there is provided a network management apparatus. The network management apparatus includes at least one processor. The processor is configured to execute a reception process of receiving a signal supplied when degradation in performance of a VNF or a CNF exceeding a threshold value is detected in a network virtualization environment, a specifying process of specifying a hardware resource related to performance degradation when the signal is received, and a first command transmission process of transmitting a command to perform auto-healing so as to deploy a hardware resource other than the hardware resource for the VNF or CNF having degraded performance.

According to another aspect of the present disclosure, there is provided a network management method. The network management method includes receiving a signal supplied when degradation in performance of a VNF or a CNF exceeding a threshold value is detected in a network virtualization environment; specifying a hardware resource related to performance degradation when the signal is received; and transmitting a command to perform auto-healing so as to deploy a hardware resource other than the hardware resource for the VNF or CNF having degraded performance.

In the aspects of the present disclosure, an adverse effect on a service may be automatically minimized as quickly as possible in a case in which degradation in performance of a component that may result in a silent failure occurs in a network implemented in a virtualization environment.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a block diagram illustrating components in a network virtualization environment defined by ETSI NFV;

FIG. 2 is a diagram illustrating an installation example of a determination device according to the present disclosure;

FIG. 3 is a diagram illustrating another installation example of the determination device according to the present disclosure;

FIG. 4 is a diagram illustrating still another installation example of the determination device according to the present disclosure;

FIG. 5 is a diagram illustrating still yet another installation example of the determination device according to the present disclosure;

FIG. 6 is a block diagram illustrating an example of a hardware configuration of the determination device;

FIG. 7 is a table illustrating examples of monitored items of performance of a VNF or a CNF according to the present disclosure;

FIG. 8 is a sequence diagram illustrating an example of a process in the network virtualization environment according to the present disclosure;

FIG. 9 is a flowchart illustrating a determination operation of the determination device; and

FIG. 10 is a diagram for describing details of a determination operation of the determination device.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

Hereinafter, embodiments according to the present disclosure will be described with reference to the accompanying drawings.

FIG. 1 is a block diagram illustrating components in a network virtualization environment defined by ETSI NFV.

Solid lines in FIG. 1 represent logical connections between components.

A virtual network function (VNF) corresponds to an application or the like operating in a virtual machine (VM) on a server, and implements network functions such as a directory service, a router, a firewall, and a load balancer in a software manner. As the VNF, an element of an evolved packet core (EPC) which is a core network of a mobile network or an element of an IP multimedia subsystem (IMS) may be implemented by software (virtual machine).

A containerized network function or cloud-native network function (CNF) is an evolved form of the VNF, corresponds to an application or the like operating in a container on a server, and implements a network function in a software manner. As the CNF, an element of the EPC or an element of the IMS may be implemented by software (container).

Hereinafter, “VNF/CNF” means “VNF” or “CNF”.

An element management system (EMS) is a management function for each VNF/CNF. Each EMS is connected to a corresponding VNF/CNF to monitor the VNF/CNF.

A network function virtualization infrastructure (NFVI) forms an execution basis of the VNF/CNF. The NFVI is a base that enables flexible handling as virtualized hardware resources such as virtualized computing, virtualized storage, and virtualized network in which hardware resources of physical machines (servers) such as computing, storage, and network functions are virtualized in a virtualization layer such as a hypervisor.

In practice, a plurality of NFVIs are provided, and each NFVI is connected to a plurality of VNFs/CNFs to monitor the VNFs/CNFs.

A virtualized infrastructure manager (VIM) serves as a cloud controller. That is, the VIM controls the NFVI via a virtualization layer (performs computing, storage, network resource management, problem monitoring of the NFVI that is an execution basis of the NFV, resource information monitoring, and the like).

In practice, a plurality of VIMs are provided, and each VIM is connected to a large number of NFVIs to monitor the NFVIs.

A VNF Manager (VNFM) manages VNFs/CNFs. Specifically, the VNFM controls the NFVI via the virtualization layer (performs computing, storage, network resource management, problem monitoring of the NFVI, resource information monitoring, and the like).

In practice, a plurality of VNFMs are provided, and each VNFM is connected to a plurality of VNFs/CNFs and a plurality of VIMs to monitor the VNFs/CNFs and the VIMs.

An NFV orchestrator (NFVO) performs orchestration of NFVI resources, management of network resources, and management of network services. The NFVO has a repository of NFV instances and a repository of NFVI resources.

The NFVO is connected to a plurality of VNFMs and a plurality of VIMs to monitor the VNFMs and the VIMs.

The NFVO has a function of transmitting a command for auto-healing to a component related to the auto-healing in order to recover a VNF/CNF having a problem, in a case of receiving a report indicating that the component of a virtualization environment has the problem.

Further, the NFVO has a function of transmitting an auto-scaling command to a component related to auto-scaling in order to automatically add a new VNF/CNF, in a case of receiving a report indicating that the processing load of the component in the virtualization environment exceeds an allowable value.

The NFVO, the VNFM, and the VIM constitute a management and orchestration (MANO). The MANO has a management function of a virtualization environment and an orchestration function.

An operations support system (OSS) is a system (device, software, mechanism, or the like) necessary for a communication company (carrier) to construct and operate a service. A business support system (BSS) is an information system (device, software, mechanism, or the like) used by a communication company (carrier) for charging, billing, customer service, and the like.

The OSS and the BSS function in cooperation with each other, and may be provided integrally and inseparably. In the following description, “OSS/BSS” means a system including both an OSS and a BSS, but the OSS and the BSS may be separately provided.

The OSS/BSS is connected to the NFVO and is connected to a plurality of EMSs.

In some virtualization environments, some (including controlling auto-healing and auto-scaling) of the functions of the NFVO may be performed in the OSS. In a case in which the OSS performs functions related to reception of a report of a problem related to auto-healing and auto-scaling and a command for auto-healing and auto-scaling (control of auto-healing and auto-scaling), a connection corresponding to the solid line between the OSS/BSS and the NFVO in the drawings is used to receive the report and transmit the command.

That is, auto-healing and auto-scaling are controlled by the OSS or the NFVO. In the following description, “OSS/NFVO” means the OSS or the NFVO.

As described above, the VNF/CNF may serve as an element of an EPC or an element of an IMS for mobile services.

Therefore, there is a network for the application (VNF/CNF) to provide mobile services. The thick solid line in FIG. 1 indicates a mobile service network used for mobile services in the virtualization environment.

The mobile service network connects a mobile network Mo and a plurality of VNFs/CNFs. The VNFs/CNFs communicate with the mobile network Mo via the mobile service network and communicate with each other via the mobile service network.

A plurality of logical networks are used in a virtualization environment to perform auto-healing and auto-scaling.

First, a platform monitoring network between the VIM and the NFVI is used. Each VIM is connected to a plurality of NFVIs, and the NFVI reports a problem of a hardware resource on which the VNF/CNF operates or performance degradation to the VIM. That is, each VIM monitors the subordinate NFVI by using the platform monitoring network between the VIM and the NFVI.

In addition, the platform monitoring network between the OSS/NFVO and the VIM is used. The NFVO is connected to a plurality of VIMs, and each VIM reports, to the NFVO, a problem of a hardware resource or performance degradation reported from the NFVI. In a case in which the OSS controls auto-healing and auto-scaling, the NFVO transfers a report of the problem or the performance degradation to the OSS via a connection between the OSS and the NFVO.

As described above, the platform monitoring network is used for reporting the problem of a hardware resource on which the VNF/CNF operates or the performance degradation.

An auto-healing command and an auto-scaling command related to the hardware resources are transmitted via the platform control network between the OSS/NFVO and the VIM. In a case in which the OSS controls auto-healing and auto-scaling, the OSS supplies a command to the NFVO via the connection between the OSS and the NFVO. The NFVO supplies a command to a VIM corresponding to a VNF/CNF having a problem or degraded performance.

The auto-healing command related to the hardware resource is a command for deleting a VNF/CNF having a problem and deploying another hardware resource for the VNF/CNF (creating a VNF/CNF). The auto-scaling command related to the hardware resource is a command for adding a new VNF/CNF and deploying the hardware resource for the VNF/CNF.

On the other hand, an application monitoring network (a network between the VNFM and the VNF/CNF and a connection between the EMS and the VNF/CNF) between the EMS/VNFM and the VNF/CNF is used. Each VNFM is connected to a plurality of VNFs/CNFs to monitor an application of the subordinate VNF/CNF. Each EMS is connected to the corresponding VNF/CNF to monitor an application of the VNF/CNF.

In addition, an application monitoring network (a network between the NFVO and the VNFM, a connection between the OSS and the EMS, and a connection between the OSS and the NFVO) between the OSS/NFVO and the EMS/VNFM is used. The NFVO is connected to a plurality of VNFMs, and each VNFM reports, to the NFVO, a problem of an application of the VNF/CNF or performance degradation. In a case in which the OSS controls auto-healing and auto-scaling, the NFVO transfers a report of the problem or the performance degradation to the OSS via a connection between the OSS and the NFVO. The OSS/BSS is connected to a plurality of EMSs, and each EMS may report a problem of an application of the VNF/CNF to the OSS/BSS. In a case in which the OSS does not control auto-healing and auto-scaling, the OSS transfers, to the NFVO, a report of the problem or the performance degradation via the connection between the OSS and the NFVO.

As described above, the application monitoring network is used to report the problem of the application of the VNF/CNF or performance degradation.

An auto-healing command and an auto-scaling command related to an application are transmitted via the application control network (a network between the NFVO and the VNFM, a connection between the OSS and the EMS, and a connection between the OSS and the NFVO) between the OSS/NFVO and the EMS/VNFM. In a case in which the OSS controls auto-healing and auto-scaling, the OSS supplies a command to the NFVO, and the NFVO transfers the command to the VNFM corresponding to the created or added VNF/CNF, or supplies the command to the EMS corresponding to the created or added VNF/CNF. In a case in which the OSS does not control auto-healing and auto-scaling, the NFVO supplies a command to the OSS, and the OSS transfers the command to the EMS corresponding to the created or added VNF/CNF, or supplies the command to the VNFM corresponding to the created or added VNF/CNF.

The auto-healing command related to the application is a setting command for optimizing the operation of the created VNF/CNF (that is, incorporating the VNF/CNF into the operation). The auto-scaling command related to the application is a setting command for optimizing the operation of the added VNF/CNF (that is, incorporating the VNF/CNF into the operation).

As described above, in the virtualization environment, in a case in which there is a problem in the hardware resource or application of a VNF/CNF, auto-healing can be performed. In addition, in a case in which performance of a hardware resource or an application of a VNF/CNF is degraded, auto-scaling can be performed.

Performance degradation of a VNF/CNF that may cause a silent failure usually does not result in auto-healing, but may result in auto-scaling. The VNF/CNF added by auto-scaling may exhibit the favorable performance. However, the VNF/CNF having the degraded performance is also continuously used, and a silent failure may continue.

Therefore, in the present embodiment, in a case in which performance of a VNF/CNF is degraded, which may cause a silent failure, adverse effects on service are automatically minimized as quickly as possible. Specifically, in the present embodiment, the reception process of receiving a signal supplied when degradation in performance of a VNF/CNF exceeding a threshold value is detected in a network virtualization environment, the specifying process of specifying a hardware resource related to performance degradation when the signal is received, and the first command transmission process of transmitting a command to perform auto-healing so as to deploy a hardware resource other than the specified hardware resource for the VNF or CNF having degraded performance are executed. By excluding hardware resources related to the performance degradation and performing auto-healing, it is possible to automatically minimize adverse effects on the service quickly.

In a case in which the signal is received in the reception process, and in a case in which the predetermined condition is satisfied, the second command transmission process of transmitting a command to perform auto-scaling is executed.

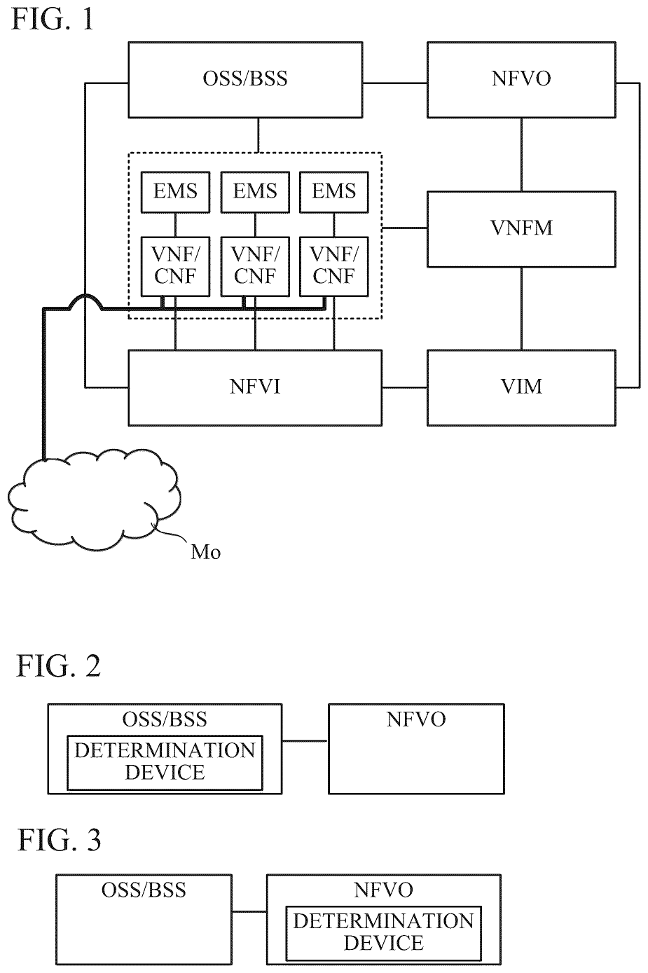

In the present embodiment, the determination device that determines whether to perform auto-healing or auto-scaling is provided. FIGS. 2 to 5 illustrate installation examples of the determination device, respectively.

In the example of FIG. 2, the determination device is provided in the OSS/BSS. This is suitable in a case in which the OSS controls auto-healing and auto-scaling.

In the example of FIG. 3, the determination device is provided in the NVFO. This is suitable in a case in which the OSS does not control auto-healing and auto-scaling.

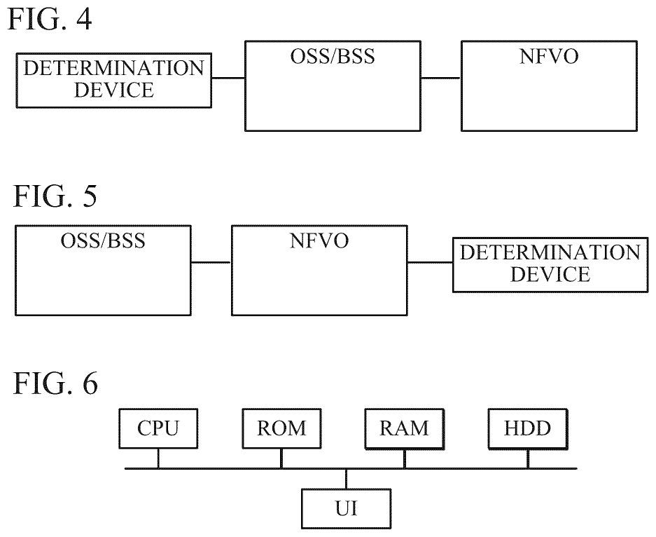

In the example of FIG. 4, the determination device is connected to the OSS/BSS. This is suitable in a case in which the OSS controls auto-healing and auto-scaling.

In the example of FIG. 5, the determination device is connected to the NVFO. This is suitable in a case in which the OSS does not control auto-healing and auto-scaling.

As illustrated in FIG. 6, the determination device includes a central processing unit (CPU), that is, a processor, a read only memory (ROM), a random access memory (RAM), a hard disk drive (HDD), and a user interface (UI).

The ROM or the HDD stores a computer program required for an operation of the determination device. The ROM or the HDD stores data such as parameters required for the operation of the determination device.

The CPU executes a computer program stored in the ROM or the HDD while using data stored in the ROM or the HDD, and operates in accordance with the computer program.

The RAM is used as a work area of the CPU.

The UI may be a combination of a display device and a pointing device (for example, a mouse or a touch pad), or may be a touch panel having functions of both the display device and the pointing device. A user of the determination device can provide instructions to the CPU by using the UI.

In the installation examples of FIGS. 4 and 5, the determination device includes a communication interface (not illustrated) for communicating with the OSS or the NVFO.

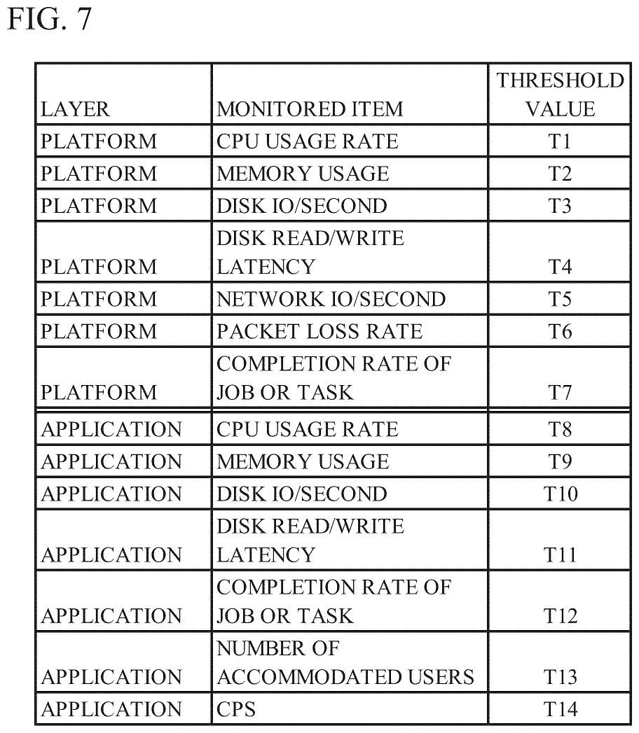

FIG. 7 is a table illustrating examples of monitored items of performance of a VNF/CNF according to the present embodiment. As described above, the VNF/CNF may serve as an element of an EPC or an element of an IMS of mobile services, and a monitored item mainly relates to performance related to the mobile service.

The performance degradation of the monitored item of the platform layer of FIG. 7 is reported by the above platform monitoring network. Thus, data corresponding to the monitored items (CPU usage rate to completion rate of a job or a task) of the platform layer of FIG. 7 and threshold values (T1 to T7) is stored in each VIM. The monitored item of the platform layer may be monitored for each VNF/CNF, or may be monitored for each process that is operated on the NFVI being the platform of the VNF/CNF.

The performance degradation of the monitored item of the above application layer in FIG. 7 is reported by the application monitoring network. Therefore, data corresponding to the monitored item (CPU usage rate to CPS) of the application layer in FIG. 7 and threshold values (T8 to T14) is stored in each VNFM and each EMS. The monitored item of the application layer may be monitored for each VNF/CNF, or may be monitored for each process that is operated on the application of the VNF/CNF.

The disk IO/second is the number of times of reading and writing from and to a disk per unit time. The network IO/second is the number of transmissions and receptions to and from the mobile network per unit time. The number of accommodated users is the number of UEs (User Equipment) for which the VNF/CNF provides the mobile service. The CPS is a calls per second (CPS) in the mobile service provided by the VNF/CNF.

Each VIM compares each monitored item of the platform layer of FIG. 7 to the corresponding threshold value (any of T1 to T7). In a case in which the CPU usage rate exceeds the threshold value T1, it is assumed that the performance of the VNF/CNF is degraded. In a case in which the memory usage exceeds the threshold value T2, it is also assumed that the performance of the VNF/CNF is degraded. In a case in which the disk IO/second is lower than the threshold value T3, it is assumed that the performance of the VNF/CNF is degraded. In a case in which the disk read/write latency exceeds the threshold value T4, it is also assumed that the performance of the VNF/CNF is degraded. In a case in which the network IO/s is lower than the threshold value T5, it is also assumed that the performance of the VNF/CNF is degraded. In a case in which the packet loss rate exceeds the threshold value T6, it is also assumed that the performance of the VNF/CNF is degraded. In a case in which the completion rate of a job or a task is lower than the threshold value T7, it is also assumed that the performance of the VNF/CNF is degraded.

Therefore, in a case in which any of the above is applicable, the VIM transmits a signal indicating performance degradation to the OSS/NFVO.

Each VNFM and each EMS compare each monitored item of the application layer in FIG. 7 with the corresponding threshold value (any of T8 to T14). In a case in which the CPU usage rate exceeds the threshold value T8, it is assumed that the performance of the VNF/CNF is degraded. In a case in which the memory usage exceeds the threshold value T9, it is also assumed that the performance of the VNF/CNF is degraded. In a case in which the disk IO/second is lower than the threshold value T10, it is assumed that the performance of the VNF/CNF is degraded. In a case in which the disk read/write latency exceeds the threshold value T11, it is also assumed that the performance of the VNF/CNF is degraded. In a case in which the completion rate of a job or a task is lower than the threshold value T12, it is also assumed that the performance of the VNF/CNF is degraded. In a case in which the number of accommodated users is lower than the threshold value T13, it is also assumed that the performance of the VNF/CNF is degraded. In a case in which the CPS exceeds the threshold value T14, it is also assumed that the performance of the VNF/CNF is degraded.

Therefore, in a case in which any of the above is applicable, the VNFM or the EMS transmits a signal indicating performance degradation to the OSS/NFVO.

In the present embodiment, the CPU usage rate, the memory usage, the disk IO/second, the disk read/write latency, and the completion rate of a job or a task of the VNF/CNF are monitored in both the platform layer and the application layer. The threshold value T1 may be the same as the threshold value T8. The threshold value T2 may be the same as the threshold value T9. The threshold value T3 may be the same as the threshold value T10. The threshold value T4 may be the same as the threshold value T11. The threshold value T7 may be the same as the threshold value T12. These monitored items may be monitored by only one of the platform layer and the application layer.

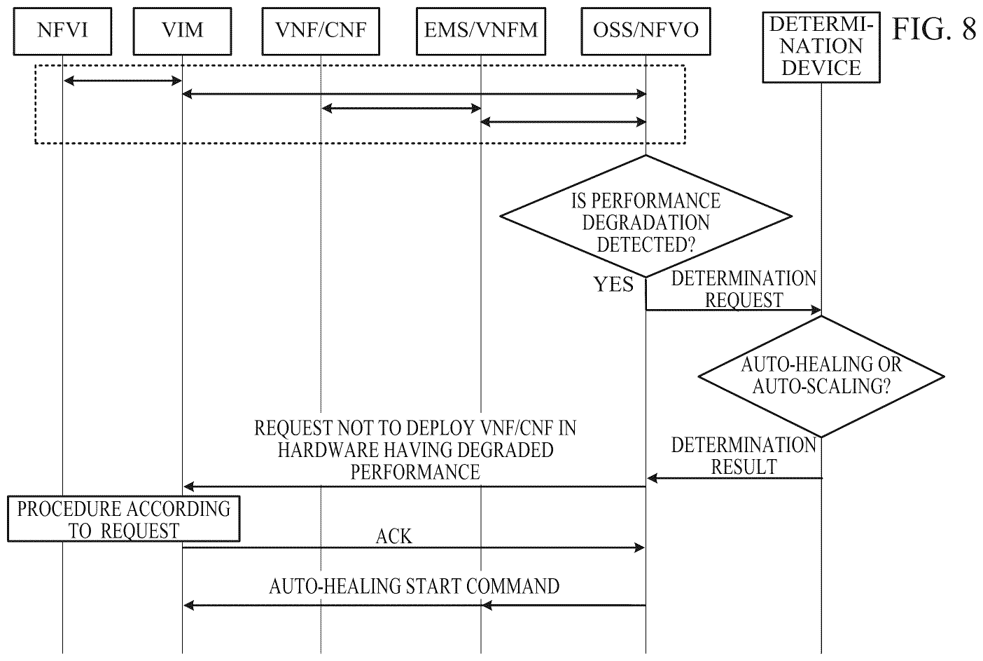

The sequence diagram of FIG. 8 illustrates an example of a process in the virtualization environment according to the present embodiment.

The inside of the rectangle indicated by broken lines in FIG. 8 shows signal exchange between components in the platform monitoring network and application monitoring network described above.

In a case in which the VIM, the VNFM, or the EMS reports a signal indicating performance degradation to the OSS/NFVO, the determination block “IS PERFORMANCE DEGRADATION DETECTED?” in FIG. 8 is affirmative. In this case, the OSS/NFVO records the report of the performance degradation, and transmits a determination request signal for requesting determination as to whether to perform auto-healing or auto-scaling to the determination device. The determination request signal includes information for identifying a VNF/CNF having the degraded performance.

Upon receiving the determination request signal, the CPU of the determination device determines whether to perform auto-healing or auto-scaling.

The CPU of the determination device transmits the determination result as a response to the OSS/NFVO. In accordance with the determination result, the OSS/NFVO performs auto-healing or auto-scaling.

In a case in which it is determined that auto-healing should be performed, the CPU of the determination device executes the specifying process of specifying hardware resources related to the performance degradation of the VNF/CNF. The determination result, which is transmitted as a response from the determination device to the OSS/NFVO and commands to perform auto-healing, includes information for identifying the hardware resource specified in the specifying process.

Upon receiving the determination result that commands to perform auto-healing, the OSS/NFVO transmits a request not to deploy a VNF/CNF on the specified hardware resource related to the performance degradation to the VIM corresponding to the VNF/CNF having the degraded performance. In accordance with this request, the VIM and the NFVI corresponding to the VNF/CNF having the degraded performance perform a procedure of excluding the specified hardware resource related to the degraded performance from the hardware resource for the VNF/CNF to be restored. After completing the procedure, the VIM transmits a completion confirmation signal (ACK) as a response to the OSS/NFVO.

In response to the completion confirmation signal, the OSS/NFVO transmits an auto-healing start command to the VIM. Upon receiving the auto-healing start command, the VIM deletes the VNF/CNF having the degraded performance and deploys other hardware resources for the VNF/CNF (creating a VNF/CNF). Although not illustrated, after the creation of the VNF/CNF is completed, the OSS/NFVO commands the VNFM or the EMS corresponding to the created VNF/CNF to perform setting for incorporating the created VNF/CNF into the operation. In accordance with the command, the VNFM or the EMS performs setting for incorporating the created VNF/CNF into the operation.

Although not illustrated, upon receiving a determination result that commands to perform auto-scaling, the OSS/NFVO transmits a command to perform auto-healing to the VIM corresponding to the VNF/CNF having the degraded performance. Upon receiving this command, the VIM adds a new VNF/CNF and deploys a hardware resource for the VNF/CNF. After the addition of the VNF/CNF is completed, the OSS/NFVO commands the VNFM or the EMS corresponding to the added VNF/CNF to perform setting for incorporating the added VNF/CNF into the operation. In accordance with the command, the VNFM or the EMS performs setting for incorporating the added VNF/CNF into the operation.

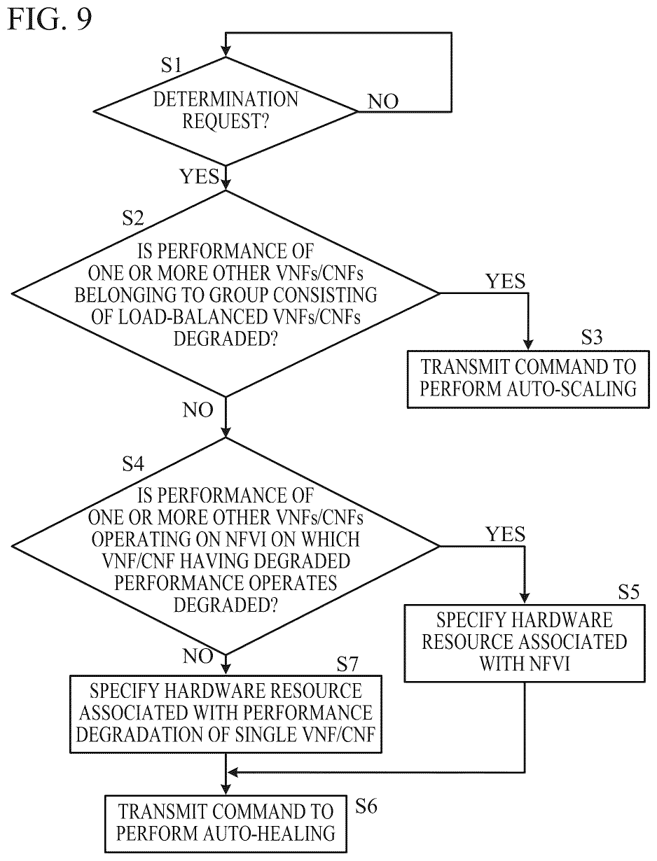

Next, the determination operation of the CPU of the determination device will be described in more detail with reference to the flowchart of FIG. 9.

In Step S1, the CPU determines whether or not a determination request signal is received from the OSS/NFVO. When the determination in Step S1 is affirmative, the operation proceeds to Step S2, in which the CPU determines whether or not a determination request signal has already been received for the performance degradation of one or more other VNFs/CNFs belonging to a group consisting of a plurality of load-balanced VNFs/CNFs, the group including the VNF or CNF having the degraded performance. That is, in a case in which the VNF/CNF that has the degraded performance and has caused the determination request signal in Step S1 belongs to a group consisting of a plurality of load-balanced VNFs or CNFs, the CPU of the determination device executes the first determination process of determining whether or not degradation in performance of one or more other VNFs/CNFs belonging to the group exceeding a threshold value has already been detected.

In a case in which the determination in Step S2, that is, the determination in the first determination process is affirmative, the operation proceeds to Step S3, and the CPU of the determination device transmits a determination result that commands to perform auto-scaling as a response to the OSS/NFVO (executes the second command transmission process). In this manner, auto-scaling is performed.

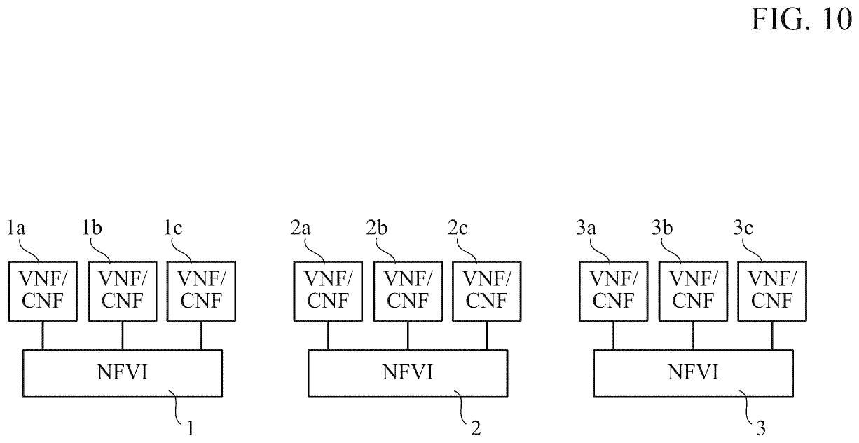

The determination in Step S2 will be described in more detail with reference to FIG. 10. As illustrated in FIG. 10, it is assumed that a plurality of VNFs/CNFs 1a to 1c are executed by one NFVI 1, a plurality of VNFs/CNFs 2a to 2c are executed by one NFVI 2, and a plurality of VNFs/CNFs 3a to 3c are executed by one NFVI 3. Then, it is assumed that the VNFs/CNFs 1a, 2a, and 3a belong to the same group and are subjected to load balancing, the VNFs/CNFs 1b, 2b, and 3b belong to the same group and are subjected to load balancing, and the VNFs/CNFs 1c, 2c, and 3c belong to the same group and are subjected to load balancing.

In a case in which the performance is degraded in all the VNFs/CNFs (for example, VNFs/CNFs 1a, 2a, and 3a) belonging to the load-balanced group, it is difficult to consider that there is a physical defect of hardware related to all the VNFs/CNFs or a defect of software such as firmware that operates on the hardware. Rather, it is assumed that the load on the group is excessive.

Thus, in a case in which the determination in Step S2, that is, the determination in the first determination process is affirmative, the operation proceeds to Step S3, and auto-scaling is performed. In auto-scaling in this case, the OSS/NFVO may transmit a command for auto-scaling to a plurality of components (a plurality of VIMs, a plurality of VNFMs, and a plurality of EMSs) corresponding to a plurality of VNFs/CNFs having the degraded performance.

On the other hand, in a case in which the performance of only one VNF/CNF (for example, VNF/CNF 2a) among the VNFs/CNFs belonging to one load-balanced group (for example, VNFs/CNFs 1a, 2a, and 3a) is degraded, it is assumed that the load on the group is not excessive, but only the VNF/CNF (for example, VNF/CNF 2a) is abnormal, and a silent failure may have occurred in the VNF/CNF. In this case, there is a high probability of being reasonable to perform auto-healing while excluding hardware resources related to performance degradation.

In a case in which the determination in Step S2, that is, the determination in the first determination process is negative, the operation proceeds to Step S4. In Step S4, the CPU of the determination device determines whether or not a determination request signal has already been received for the performance degradation of one or more other VNFs/CNFs that operate on the NFVI on which the VNF/CNF having the degraded performance operates. That is, the CPU executes the second determination process of determining whether or not it has been already detected that the degradation in the performance of one or more other VNFs/CNFs that operate on the NFVI on which the VNF/CNF having the degraded performance operates exceeds the threshold value, which is related to the determination request signal in Step S1.

In a case in which the determination in Step S4, that is, the determination in the second determination process is affirmative, the operation proceeds to Step S5, and the CPU of the determination device executes the specifying process of specifying the hardware resource related to the NFVI in which a plurality of subordinate VNFs/CNFs have a problem. That is, in Step S5, the hardware resource related to the NFVI having a problem is specified as the hardware resource related to the performance degradation of the VNF/CNF.

Then, in Step S6, the CPU of the determination device transmits, as a response to the OSS/NFVO, a determination result that commands to perform auto-healing (executes the first command transmission process). In a case in which Step S5 is executed immediately before Step S6, the determination result that commands to perform auto-healing includes information for identifying the hardware resource specified in Step S5. In this manner, auto-healing is performed to deploy hardware resources other than the hardware resources specified in Step S5 for the VNF/CNF having the degraded performance.

In a case in which the determination in Step S4, that is, the determination in the second determination process is negative, the operation proceeds to Step S7, and the CPU of the determination device executes the specifying process of specifying hardware resources related to performance degradation of a single VNF/CNF having the degraded performance, which is related to the determination request signal in Step S1. That is, in Step S7, the hardware resource related to only the VNF/CNF is specified as the hardware resource related to the performance degradation of the VNF/CNF.

Then, in Step S6, the CPU of the determination device transmits, as a response to the OSS/NFVO, a determination result that commands to perform auto-healing (executes the first command transmission process). In a case in which Step S7 is executed immediately before Step S6, the determination result that commands to perform auto-healing includes information for identifying the hardware resource specified in Step S7. In this manner, auto-healing is performed to deploy hardware resources other than the hardware resources specified in Step S7 for the VNF/CNF having the degraded performance.

The determination in Step S4 will be described in more detail with reference to FIG. 10. A plurality of VNFs/CNFs operating on the same NFVI (server) correspond to different applications that operate on the same server. For example, the VNFs/CNFs 2a to 2c operating on the NFVI 2 correspond to different applications that operate on the same server.

In a case in which performance is degraded in different applications that operate on the same server, it is difficult to consider that all of these applications have a defect. Rather, it is assumed that the server is abnormal. For example, in a case in which the performance is degraded in all of the VNFs/CNFs 2a to 2c operating on the NFVI 2, it is assumed that the NFVI 2 is abnormal rather than the defects of the VNFs/CNFs 2a to 2c.

Thus, in a case in which the determination in Step S4, that is, the determination in the second determination process is affirmative, the operation proceeds to Step S5, and the hardware resource related to the NFVI in which a plurality of subordinate VNFs/CNFs have a problem is specified as the hardware resource to be excluded by auto-healing.

On the other hand, in a case in which the performance is not degraded in other applications operating on the same server, it is assumed that only the VNF/CNF corresponding to the application having the degraded performance is abnormal. Thus, in a case in which the determination in Step S4, that is, the determination in the second determination process is negative, the operation proceeds to Step S7, and the hardware resource related to only the VNF/CNF is specified as the hardware resource to be excluded by auto-healing.

As described above, in the present embodiment, in a case in which performance of a VNF/CNF is degraded, which may cause a silent failure in the network implemented in the virtualization environment, auto-healing is appropriately performed, so that adverse effects on services may be automatically minimized as quickly as possible. In addition, in a case in which it is assumed that performing of auto-scaling is appropriate, auto-scaling is performed. Further, in a case in which it is assumed that the performance degradation of the VNF/CNF is caused by the NFVI, hardware resources related to the NFVI are excluded in auto-healing. In a case in which it is assumed that the performance degradation of the VNF/CNF is caused only by the VNF/CNF, hardware resources related to the VNF/CNF are excluded in auto-healing.

Steps S2 and S3 may be omitted. In this case, when the determination in Step S1 is affirmative, the operation directly proceeds to Step S4.

Steps S4 and S5 may be omitted. In this case, when the determination in Step S2 is negative, the operation directly proceeds to Step S7, and further proceeds to Step S6.

Although the present disclosure has been illustrated and described above with reference to preferred embodiments of the present disclosure, it will be understood by those skilled in the art that changes in form and details may be made without departing from the scope of the claims. Such changes, modifications, and corrections should fall within the scope of the present disclosure.

Aspects of the present disclosure are also set forth in the following numbered clauses:

[1] A network management apparatus including:
at least one processor configured to execute
a reception process of receiving a signal supplied when degradation in performance of a VNF or a CNF exceeding a threshold value is detected in a network virtualization environment,
a specifying process of specifying a hardware resource related to performance degradation when the signal is received, and
a first command transmission process of transmitting a command to perform auto-healing so as to deploy a hardware resource other than the hardware resource for the VNF or CNF having degraded performance.

[2] The network management apparatus according to [1], wherein the processor is further configured to execute
a first determination process of determining, after the reception process and before the specifying process, whether or not degradation in performance exceeding a threshold value is detected in one or more other VNFs or CNFs belonging to a group consisting of a plurality of load-balanced VNFs or CNFs, the group including the VNF or CNF having the degraded performance, and
a second command transmission process of transmitting a command to perform auto-scaling in a case in which a determination in the first determination process is affirmative.

[3] The network management apparatus according to [1] or [2], wherein the processor is further configured to
execute, after the reception process and before the specifying process, a second determination process of determining whether or not degradation in performance exceeding a threshold value is detected in one or more other VNFs or CNFs that operate on an NFVI on which the VNF or CNF having the degraded performance operates,
specify a hardware resource related to the NFVI in the specifying process in a case in which the determination in the second determination process is affirmative, and
specify a hardware resource related to the VNF or CNF having the degraded performance in the specifying process in a case in which the determination in the second determination process is negative.

[4] A network management method including:
receiving a signal supplied when degradation in performance of a VNF or CNF exceeding a threshold value is detected in a network virtualization environment;
specifying a hardware resource related to performance degradation when the signal is received; and
transmitting a command to perform auto-healing so as to deploy a hardware resource other than the hardware resource for the VNF or CNF having degraded performance.

What is claimed is:

1. A network management apparatus comprising:
at least one processor configured to execute
a reception process of receiving a signal supplied when degradation in performance of a VNF or a CNF exceeding a threshold value is detected in a network virtualization environment,
a specifying process of specifying a hardware resource related to performance degradation when the signal is received, and
a first command transmission process of transmitting a command to perform auto-healing so as to deploy a hardware resource other than the hardware resource for the VNF or CNF having degraded performance.

2. The network management apparatus according to claim 1, wherein the processor is further configured to execute
a first determination process of determining, after the reception process and before the specifying process, whether or not degradation in performance exceeding a threshold value is detected in one or more other VNFs or CNFs belonging to a group consisting of a plurality of load-balanced VNFs or CNFs, the group including the VNF or CNF having the degraded performance, and
a second command transmission process of transmitting a command to perform auto-scaling in a case in which the determination in the first determination process is affirmative.

3. The network management apparatus according to claim 1, wherein the processor is further configured to
execute, after the reception process and before the specifying process, a second determination process of determining whether or not degradation in performance exceeding a threshold value is detected in one or more other VNFs or CNFs that operate on an NFVI on which the VNF or CNF having the degraded performance operates,
specify a hardware resource related to the NFVI in the specifying process in a case in which the determination in the second determination process is affirmative, and
specify a hardware resource related to the VNF or CNF having the degraded performance in the specifying process in a case in which the determination in the second determination process is negative.

4. A network management method comprising:
receiving a signal supplied when degradation in performance of a VNF or CNF exceeding a threshold value is detected in a network virtualization environment;
specifying a hardware resource related to performance degradation when the signal is received; and
transmitting a command to perform auto-healing so as to deploy a hardware resource other than the hardware resource for the VNF or CNF having degraded performance.
